(19) United States
(12) Patent Application Publication
(10) Pub. No.: US 2006/0155452 A1
(43) Pub. Date: Jul. 13, 2006

(54) Method for operating a drive train of a motor vehicle

(76) Inventor: Jochen Strenkert, Stuttgart (DE)

Correspondence Address: WILLIAM COLLARD;COLLARD & ROE, P.C., 1077 NORTHERN BOULEVARD, ROSLYN, NY, 11576, US

(21) Appl. No.: 10/541,902

(22) PCT Filed: Nov. 24, 2004
(86) PCT No.: PCT/EP04/13324

§ 371 Date: Jul. 11, 2005

(30) Foreign Application Priority Data
Jan. 20, 2004 (DE) 10 2004 002 761.7

(51) Int. Cl. G06F 17/00

(52) U.S. Cl. 701/54; 701/65

(57) ABSTRACT

1. Method for operating a drive train of a motor vehicle. 2.1. A torque which is output by a drive machine may be limited by a control device in order to protect a transmission. The object of the invention is to propose a method by means of which the transmission is protected against damage by excessively high temperatures.

2.2. The control device determines a maximum acceptable power (Pₘₐₓ) from a characteristic curve (32) as a function of temperature information of the transmission. Using a rotational speed of the drive machine the control device determines from said maximum acceptable power (Pₘₐₓ) a maximum acceptable torque (Mₘₐₓ) to which the torque which is output by the drive machine is limited. 2.3. For use in a motor vehicle.

The invention relates to a method for operating a drive train of a motor vehicle according to the preamble of claim 1.

DE 698 10 715 T2 describes a drive device in a drive train of a motor vehicle and a method for controlling the drive train. The drive train has a drive machine in the form of an engine, a transmission in the form of an infinitely variable wrap-around gear mechanism and a control device in the form of an electronic control unit by means of which the torque which is output by the drive machine can be adjusted. The control device temporarily limits the torque which is output by the drive machine in such a way that a maximum torque which can be transmitted by the wrap-around gear mechanism in the form of a drive belt is not exceeded. The transmission is thus protected against damage by excessively high input torques.

DE 197 55 128 A1 describes a control system for regulating the temperature of a transmission fluid in an automatic power shift transmission of a motor vehicle. The motor vehicle has an electronic engine control system and an oil temperature sensor for sensing a transmission temperature which correlates with the temperature of the transmission fluid. The electronic engine control system continuously reduces the torque which is output by the engine if the transmission temperature is higher than a predetermined temperature value.

In contrast with the above, the object of the invention is to propose a method by means of which the transmission is protected against damage by excessively high temperatures and the torque which is output by the drive machine is not reduced to an unnecessary degree. The object is achieved according to the invention by means of a method according to claim 1.

According to the invention, the control device evaluates temperature information relating to a temperature of the transmission, in particular relating to a temperature of a transmission oil. The temperature information may be supplied, for example by a temperature sensor on the transmission. However, it is also possible for the control device to estimate a temperature of the transmission from a plurality of input variables such as, for example, a torque which is output by the drive machine, a calculated efficiency level of the transmission, an external temperature and/or a temperature of a cooling medium by means of a temperature model. The estimation may be carried out in particular if, for reasons of cost, a temperature sensor is dispensed with or if a defect is present in the temperature sensor.

The control device limits the torque which is output by the drive machine as a function of the temperature information. The control device defines, as a function of the temperature information, a maximum acceptable power (Pₘₐₓ) of the drive machine, which decreases in particular as the temperature of the transmission increases. The control device determines a maximum acceptable torque (Mₘₐₓ) from the maximum acceptable power (Pₘₐₓ) taking into account a rotational speed of the drive machine (ω_{AM}). The torque which is output by the drive machine is then limited to the maximum acceptable torque (Mₘₐₓ). The maximum acceptable torque (Mₘₐₓ) is calculated according to the following formula:

$${M}_{max} = \frac{{p}_{max}}{{ϖ}_{AM}}$$

where Mₘₐₓ is in [Nm], Pₘₐₓ is in [W] and ω_{AM} is in [rad].

A vehicle driver uses a power actuator, for example an accelerator pedal, to predefine a setpoint value for the torque which is output by the drive machine. The control device actuates actuating elements of the drive machine, for example a throttle valve or an injection pump, in such a way that the drive machine outputs the requested setpoint value. If the setpoint value is less than a maximum acceptable torque which is dependent on the temperature information, the setpoint value which is predefined by the vehicle driver remains unchanged. If the setpoint value which is predefined by the vehicle driver is higher than the maximum acceptable torque, the setpoint value is limited to the maximum acceptable torque.

In the drive train of a motor vehicle, the adjustment of the torque is carried out by means of the drive machine and the adjustment of rotational speed is carried out by means of the transmission. The dissipated power (and thus the necessary cooling capacity) of the transmission is dependent on the power to be transmitted by the transmission.

When there is a risk of the transmission overheating, the power to be transmitted (and thus also the dissipated power) can be reduced by the inventive limiting of the torque of the drive machine so that the dissipated power remains in equilibrium with the cooling capacity which is carried away, or is less than the cooling capacity. This prevents a rise in the temperature of the transmission or causes the transmission to be cooled if the dissipated power is less than the cooling capacity.

The generation of heat as a result of losses in the transmission increases as the power increases. The inventive limitation of the torque as a function of the temperature information may effectively prevent overheating and thus damage to the transmission. Furthermore, a transmission radiator may be made very compact, giving rise to a design of the transmission radiator which is optimum in terms of installation space and cost-effective.

The vehicle driver is given an unpleasant impression and is incapable of following the behavior of the drive train if the maximum engine power changes very quickly or suddenly. Since the temperature of the transmission changes only very slowly, the temperature information is a very sluggish variable. As a result, the limitation may be directly dependent on the temperature information, which results in a continuous and harmonious profile of the maximum engine power, as a result of which limitation is virtually imperceptible to the vehicle driver. It is not necessary to filter or smooth transitions by means of ramps. As a result, the method can be implemented easily in the control device. Furthermore, the number of adjustable parameters thus remains small, making the drive train easy to apply in a development phase.

The control device can also define the maximum acceptable power (Pₘₐₓ) as a function of further variables, for example a temperature of the surroundings of the motor vehicle or a temperature of a cooling fluid of a transmission cooling system.

The drive machine and the transmission may be actuated together by one control device or else individually by one control device each. If more than one control device is used, the processing of the method according to the invention is divided between the various control devices. For example, a control device of the transmission may determine a maximum torque as a function of the temperature information and transmit it to a control device of the drive machine which then correspondingly adjusts the torque.

The drive machine may be embodied, for example, as an internal combustion engine or an electric motor. The transmission may be embodied, for example, as a manual or automatic change-speed gear mechanism, an automatic transmission of a planetary design or an infinitely variable transmission in the form of a friction wheel gear mechanism or wrap-around gear mechanism.

In one embodiment of the invention, the maximum acceptable power (Pₘₐₓ) of the drive machine is stored in the control device as a function of the temperature information, for example as a characteristic curve or a characteristic diagram. The maximum acceptable power (Pₘₐₓ) drops in particular as the temperature rises, for example along a straight line or a line which is composed of a plurality of line elements with different gradients. However, any other functional relationship between the temperature information and the maximum acceptable power (Pₘₐₓ) is also possible. The maximum acceptable power (Pₘₐₓ) can also remain constant or else rise temporarily when the temperature rises.

The maximum acceptable power (Pₘₐₓ) is thus particularly easy to determine.

In one embodiment of the invention the control device limits the torque only if a force flux is established between the drive machine and driven vehicle wheels, that is to say there is a drive connection between the drive machine and the driven vehicle wheels. If the force flux is not produced, the torque of the drive machine cannot be transmitted to the underlying surface. This means that the torque which is output by the drive machine can only be used to keep the drive machine operating and supply other loads such as, for example, a generator or a compressor of an air-conditioning system. If the torque which is output by the drive machine were to be limited in this case there would be the risk of the drive machine being undesirably deactivated (choked). The method according to the invention effectively prevents the drive machine from choking.

In one embodiment of the invention, the transmission has a temperature sensor which has a signal connection to the control device. The control device limits the torque as a function of the temperature information of the temperature sensor. A temperature sensor supplies very precise temperature information about the temperature of the transmission. The maximum acceptable torque (Mₘₐₓ) can thus be defined particularly precisely.

In one embodiment of the invention the transmission is embodied as an infinitely variable transmission, in particular an infinitely variable wrap-around gear mechanism. Infinitely variable gear mechanisms, in particular infinitely variable wrap-around gear mechanisms, have, according to their principle, a lower efficiency level, and thus higher dissipated power than, for example, a change-speed gear mechanism, at most operating points. The risk of damage to the transmission as a result of excessively high temperatures is thus particularly high in the case of infinitely variable transmissions. More reliable operation of an infinitely variable transmission can be ensured by means of the method according to the invention.

Further advantages of the invention emerge from the description and the drawing. Exemplary embodiments of the invention are illustrated in simplified form in the drawing and explained in more detail in the following description. In the drawing:

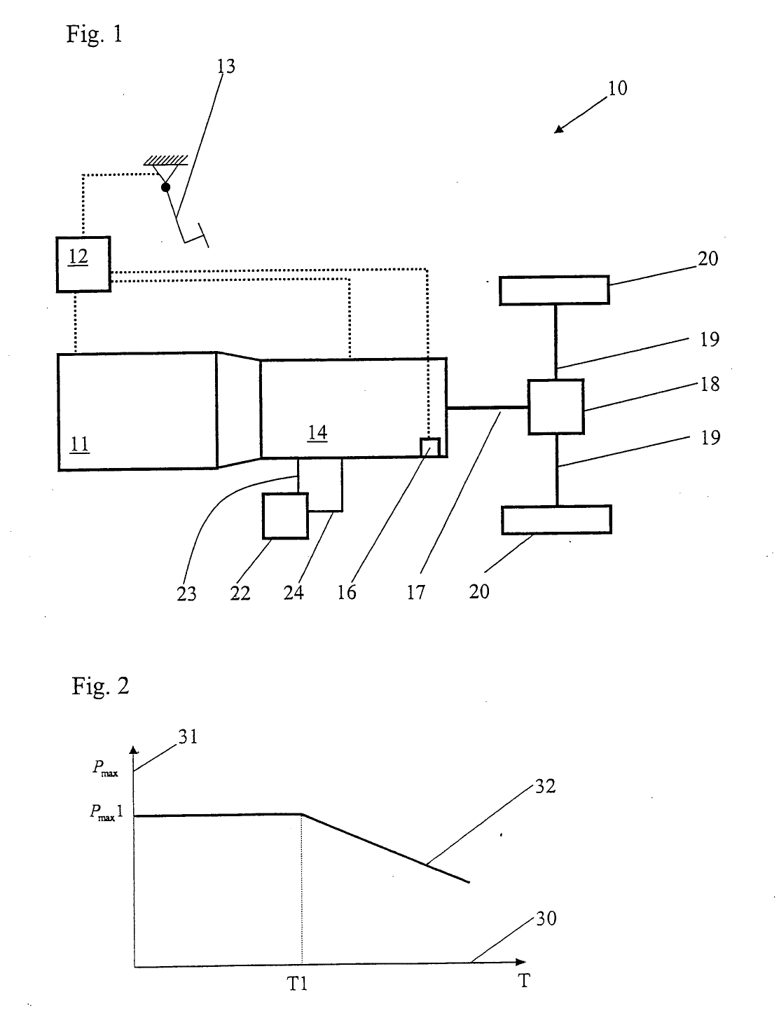

FIG. 1 shows a drive train of a motor vehicle, and

FIG. 2 shows a characteristic curve of the maximum power of the drive machine (Pₘₐₓ) as a function of a temperature of the transmission.

According to FIG. 1, a drive train 10 of a motor vehicle (not illustrated) has a drive machine 11 in the form of an internal combustion engine which is actuated by a control device 12. For this purpose, the control device 12 has a signal connection to actuating elements (not illustrated) such as, for example, a throttle valve actuator, and sensors such as, for example, rotational speed sensors. The control device 12 also has a signal connection to a power actuator 13, which is embodied as an accelerator pedal and by means of which a vehicle driver can adjust a setpoint value for the torque to be output by the internal combustion engine 11.

The internal combustion engine 11 is connected via a hydrodynamic torque converter 21 to a transmission 14 which is embodied as an infinitely variable wrap-around gear mechanism and which is also actuated by the control device 12. The control device 12 has a signal connection to a temperature sensor 16 which measures a temperature of a gear oil of the transmission 14. The control device 12 therefore receives temperature information relating to a temperature of the transmission 14 from the temperature sensor 16.

The transmission 14 is connected to a transmission radiator 22 by means of which the gear oil, and thus the transmission, can be cooled, for example by the external air. The gear oil is fed to the transmission radiator 22 via a feed line 23, and is fed back to the transmission 14 via a return line 24. The transmission radiator may be connected to a cooling circuit (not illustrated) of the drive machine 11, the cooling capacity of the transmission radiator 22 then also being dependent on a temperature of the cooling fluid of the drive machine 11.

The transmission 14 is connected by means of a drive shaft 17 to a final drive 18 which transmits, in a known fashion, the torque which is output by the drive machine 11 to driven vehicle wheels 20 via side shafts 19. Front wheels, rear wheels or else front and rear wheels of the motor vehicle can be driven.

The control device 12 determines a maximum acceptable power of the drive machine (Pₘₐₓ) from a stored characteristic curve as a function of the temperature of the transmission 14. An example of such a characteristic curve is illustrated in FIG. 2. The temperature (T) of the transmission 14 is plotted on an abscissa 30, and the maximum power of the drive machine (Pₘₐₓ) is plotted on the ordinate. The characteristic curve 32 reflects the profile of the maximum power of the drive machine (Pₘₐₓ) plotted against the temperature. The maximum power of the drive machine (Pₘₐₓ) is constant up to a temperature T1, which may be, for example, between 80 and 140° C., at a value Pₘₐₓ1 which is higher than the maximum power of the drive machine 11. Up to this temperature T1, the torque is therefore not limited, and the torque can be limited owing to other methods (not under consideration here). Starting from the temperature T1, the characteristic curve drops along a straight line with a constant gradient.

With the value which is read out from the characteristic curve 32 for the maximum power of the drive machine (Pₘₐₓ) and the rotational speed of the drive machine 11, the control device 12 determines the maximum acceptable torque (Mₘₐₓ) of the drive machine 11 according to the formula specified above. The control device 12 then checks whether a force flux is released between the drive machine 11 and the driven vehicle wheels 20. If this is the case, the setpoint value, set by the vehicle driver by means of the power actuator 13, for the torque to be output by the internal combustion engine 11 is limited by means of the calculated, maximum acceptable torque (Mₘₐₓ). The control device 12 therefore constitutes the smaller of the two aforesaid values. If no force flux is produced, the setpoint value remains unchanged.

1. A method for operating a drive train of a motor vehicle having
a drive machine (11),
a transmission (14) and
at least one control device (12) by means of which a torque which is output by the drive machine (11) can be adjusted, wherein the control device (12)
evaluates temperature information relating to a temperature of the transmission (14) and
limits the torque as a function of the temperature information in order to protect the transmission (14), characterized in that the control device (12)
defines a maximum acceptable power (Pₘₐₓ) of the drive machine (11) as a function of the temperature information,
determines a maximum acceptable torque (Mₘₐₓ) from the maximum acceptable power (Pₘₐₓ) taking into account a rotational speed of the drive machine (11), and
limits the torque which is output by the drive machine (11) to the maximum acceptable torque (Pₘₐₓ).

2. The method as claimed in claim 1, wherein the maximum acceptable power (Pₘₐₓ) of the drive machine (11) is stored in the control device (12) as a function of the temperature information.

3. The method as claimed in claim 1, wherein the control device (12) limits the torque only if a force flux is established between the drive machine (11) and driven vehicle wheels (20).

4. The method as claimed in claim 1, wherein
the transmission (14) has a temperature sensor (16) which has a signal connection to the control device (12), and
the control device (12) limits the torque as a function of the temperature information of the temperature sensor (16).

5. The method as claimed in claim 1, wherein the transmission (14) is embodied as an infinitely variable transmission, in particular an infinitely variable wrap-around gear mechanism.
